(19) United States
(12) Patent Application Publication
(10) Pub. No.: US 2018/0151154 A1
(43) Pub. Date: May 31, 2018

(54) METHOD AND APPARATUS TO PREVENT GLARE

(71) Applicant: SAMSUNG ELECTRONICS CO., LTD., Suwon-si (KR)

(72) Inventors: Heesae LEE, Yongin-si (KR); Young Hun SUNG, Hwaseong-si (KR); KeeChang LEE, Seongnam-si (KR)

(73) Assignee: SAMSUNG ELECTRONICS CO., LTD., Suwon-si (KR)

(21) Appl. No.: 15/634,782

(22) Filed: Jun. 27, 2017

(30) Foreign Application Priority Data
Nov. 29, 2016 (KR) 10-2016-0160683

(51) Int. Cl. G09G 5/10; G02B 27/01

(52) U.S. Cl. CPC G09G 5/10; G02B 27/0101; G02B 2027/014; G09G 2320/0686; G09G 2360/144; G09G 2354/00; G09G 2320/0626; G09G 2380/10

(57) ABSTRACT

A method to prevent glare includes: detecting a glare with respect to a transparent display; identifying a light source corresponding to the glare; and setting a penetration level of a target region corresponding to a shape of the light source in the transparent display.

### CROSS-REFERENCE TO RELATED APPLICATIONS

This application claims the benefit under 35 USC § 119(a) of Korean Patent Application No. 10-2016-0160683 filed on Nov. 29, 2016, in the Korean Intellectual Property Office, the entire disclosure of which is incorporated herein by reference for all purposes.

### BACKGROUND

### 1. Field

The following description relates to technology that prevents glare.

### 2. Description of Related Art

A vehicle includes a windshield through which a driver acquires a front view. The windshield includes a transparent material that transmits strong light beams radiated from a front side of the vehicle to the driver. In particular, if an oncoming vehicle in an opposite lane turns on headlights while driving at night, the driver experiences glare. If the glare is strong, the driver may be momentarily blinded.

With respect to the issue of glare, high beam control technology to control headlights of a vehicle to protect a driver of an oncoming vehicle from glare has been developed. However, the distribution of such high beam control technology is restricted due to high costs of distribution.

Thus, there is a need for technology that prevents or reduces glare experienced by a driver.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method to prevent glare includes: detecting a glare with respect to a transparent display; identifying a light source corresponding to the glare; and setting a penetration level of a target region corresponding to a shape of the light source in the transparent display.

The identifying of the light source may include determining light source information of the light source. The setting of the penetration level of the target region may include determining whether to adjust the penetration level of the target region based on the light source information.

The setting of the penetration level of the target region may include excluding a change of the penetration level of the target region, in response to a property of the light source corresponding to a penetration permission property.

The setting of the penetration level of the target region may include changing the penetration level of the target region, in response to a property of the light source corresponding to a penetration restriction property.

The setting of the penetration level of the target region may include reducing the penetration level of the target region to a restricted level, in response to a property of the light source corresponding to a penetration restriction property.

The method may further include: tracking a gaze of a user, wherein the identifying of the light source includes determining a region including a point at which light projected from the light source toward the transparent display intersects the gaze on the transparent display to be the target region.

The detecting of the glare may include monitoring a luminance with respect to a front side of the transparent display; and detecting an occurrence of the glare in response to the monitored luminance exceeding a threshold luminance.

The method may further include: generating an ambient space map indicating distances from an apparatus including the transparent display to objects positioned in front of the transparent display.

The setting of the penetration level of the target region may include adjusting the penetration level of the target region, in response to a distance between the light source and an apparatus including the transparent display being less than a threshold distance.

The method may further include: generating a luminance map by monitoring a luminance with respect to a front side of the transparent display; generating an ambient space map with respect to the front side of the transparent display; and mapping the luminance map and the ambient space map, wherein the identifying of the light source includes determining a light source region corresponding to a glare point in the ambient space map in response to the glare point being detected from the luminance map, the glare point having a luminance exceeding a threshold luminance, and determining the target region based on the light source region.

A non-transitory computer-readable medium may store instructions that, when executed by a processor, cause the processor to perform the method.

In another general aspect, an apparatus to prevent glare includes: a sensor configured to detect a glare with respect to a transparent display; and a processor configured to identify a light source corresponding to the glare, and to set a penetration level of a target region corresponding to a shape of the light source in the transparent display.

The processor may be configured to determine light source information of the light source, and to determine whether to adjust the penetration level of the target region based on the light source information.

The processor may be further configured to exclude a change of the penetration level of the target region, in response to a property of the light source corresponding to a penetration permission property.

The processor may be further configured to change the penetration level of the target region, in response to a property of the light source corresponding to a penetration restriction property.

The processor may be further configured to reduce a penetration level of the target region, in response to a property of the light source corresponding to a penetration restriction property.

The sensor may include a gaze tracker configured to track a gaze of a user. The processor may be further configured to determine a region including a point at which light projected from the light source toward the transparent display intersects the gaze on the transparent display to be the target region.

The sensor may include a luminance sensor configured to monitor a luminance with respect to a front side of the transparent display. The processor may be further configured to detect an occurrence of the glare in response to the monitored luminance exceeding a threshold luminance.

The sensor may include an ambient space sensor configured to generate an ambient space map indicating distances from the apparatus to objects positioned in front of the transparent display. The processor may be further configured to adjust the penetration level of the target region, in response to a distance between the light source and the apparatus being less than a threshold distance.

The sensor may include a luminance sensor configured to generate a luminance map by monitoring a luminance with respect to a front side of the transparent display, and an ambient space sensor configured to generate an ambient space map with respect to the front side of the transparent display. The processor may be further configured to determine a light source region corresponding to a glare point in the ambient space map, in response to the glare point being detected from the luminance map, the glare point having a luminance exceeding a threshold luminance, and to determine a target region of the transparent display based on the light source region.

Other features and aspects will be apparent from the following detailed description, the drawings, and the claims.

### BRIEF DESCRIPTION OF THE DRAWINGS

FIGS. 1 and 2 are flowcharts illustrating examples of a glare preventing method, according to an embodiment.

FIG. 3 illustrates an example of a glare preventing apparatus provided in a vehicle, according to an embodiment.

FIG. 4 illustrates an example of a target region determined by a glare preventing apparatus with respect to a transparent display, according to an embodiment.

FIG. 5 illustrates an example of determining of a penetration level based on a distance by a glare preventing apparatus, according to an embodiment.

FIG. 6 illustrates an example of determining a penetration level based on a property of a light source by a glare preventing apparatus, according to an embodiment.

FIGS. 7 and 8 are block diagrams illustrating examples of glare preventing apparatuses, according to embodiments.

Throughout the drawings and the detailed description, the same reference numerals refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Various alterations and modifications may be made to the examples. Here, the examples are not construed as limited to the disclosure and should be understood to include all changes, equivalents, and replacements within the idea and the technical scope of the disclosure.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Unless otherwise defined, all terms including technical and scientific terms used herein have the same meaning as commonly understood by one of ordinary skill in the art to which examples belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When it is determined that detailed description related to a known function or configuration may make the purpose of the examples unnecessarily ambiguous in describing the examples, the detailed description will be omitted here.

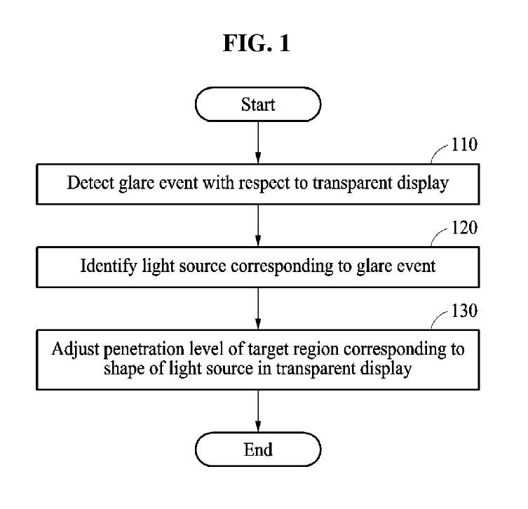

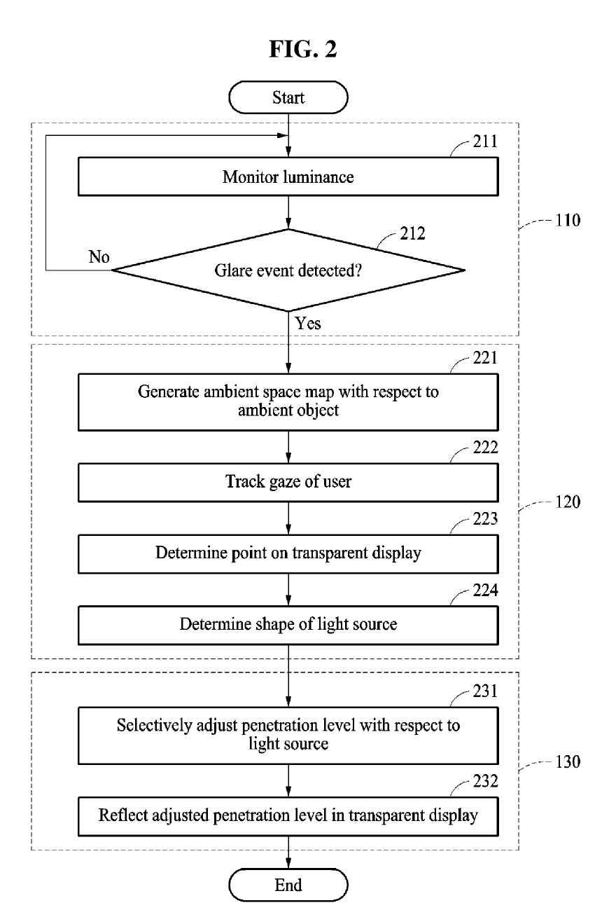

FIGS. 1 and 2 are flowcharts illustrating examples of a glare preventing method.

FIG. 1 illustrates the glare preventing method in brief. Referring to FIG. 1, in operation 110, a glare preventing apparatus detects a glare event (or, glare) with respect to a transparent display. The transparent display is a display that adjusts a penetration level of one or more regions thereof. The penetration level is a level at which light penetrates, and is also referred to as a penetration rate. The glare event is an event related to glare, and causes glare to eyes of a user. For example, the glare event is an event in which light having a brightness greater than or equal to a threshold luminance enters the transparent display. The threshold luminance is determined based on a luminance of a vicinity or a front side of a vehicle and is, for example, an average luminance value.

The glare preventing apparatus monitors a luminance at a front side of the transparent display and detects an occurrence of the glare event in response to the monitored luminance exceeding the threshold luminance.

The transparent display is disposed in front of a gaze of the user, and the front side of the transparent display is a side behind the transparent display from the user.

In operation 120, the glare preventing apparatus identifies a light source corresponding to the glare event. The glare preventing apparatus determines light source information of the light source corresponding to the glare event. The light source information includes, for example, a size, a shape, an intensity, and a property of the light source. The intensity of the light source indicates an intensity of light radiated from the light source, and the property of the light source is classified as a penetration permission property that permits penetration through the transparent display or a penetration restriction property that restricts penetration through the transparent display.

In operation 130, the glare preventing apparatus adjusts a penetration level of a target region corresponding to the shape of the light source in the transparent display. The glare preventing apparatus reduces the penetration level of the target region in the transparent display. The glare preventing apparatus changes a state of the target region to an opaque state by reducing the penetration level of the target region. Thus, the glare preventing apparatus reduces the penetration level of the target region, thereby reducing an intensity of light incident to the eyes of the user and preventing glare. The glare preventing apparatus alleviates or reduces visual fatigue of the user by preventing the glare.

FIG. 2 illustrates the glare preventing method of FIG. 1 in greater detail. Referring to FIG. 2, in operation 211, the glare preventing apparatus monitors a luminance. For example, the glare preventing apparatus monitors a luminance with respect to the front side of the transparent display.

In operation 212, the glare preventing apparatus detects a glare event. The glare preventing apparatus detects an occurrence of the glare event in response to the monitored luminance exceeding a threshold luminance. Conversely, in response to the monitored luminance being less than or equal to the threshold luminance, the glare preventing apparatus returns to operation 211 to continue monitoring the luminance. The glare preventing apparatus determines a point having a higher luminance than an ambient environment to be a point at which the glare event occurs. For example, the threshold luminance is a statistical value of luminances collected with respect to the front side of the transparent display, and includes a mean value and a median value.

In operation 221, the glare preventing apparatus generates an ambient space map with respect to an ambient object. The ambient space map is a map indicating a distance to an object present in a vicinity of the glare preventing apparatus. For example, the glare preventing apparatus generates an ambient space map indicating distances from an apparatus including the transparent display to objects positioned in front of the transparent display. The ambient space map includes space information related to a road on which a current vehicle is disposed, or in a vicinity of the current vehicle.

In operation 222, the glare preventing apparatus tracks a gaze of a user. For example, the glare preventing apparatus tracks positions of pupils of the user.

In operation 223, the glare preventing apparatus determines a point on the transparent display. For example, the glare preventing apparatus determines the point on the transparent display to be a point on the transparent display that the gaze of the user reaches, based on the tracked positions of the pupils.

In operation 224, the glare preventing apparatus determines a shape of a light source corresponding to the glare event. The glare preventing apparatus generates a three-dimensional (3D) geometric model corresponding to the shape of the light source based on the ambient space map with respect to the front side of the vehicle. For example, the glare preventing apparatus identifies the shape of the light source from a color image of the front side captured through a camera, a depth image captured through a light detection and ranging (LiDAR) sensor, or an infrared image. The glare preventing apparatus projects the 3D geometric model to a two-dimensional (2D) region on the transparent display along an axis corresponding to a direction of the gaze of the user, and determines the region to which the 3D geometric model is projected to be a target region.

In operation 231, the glare preventing apparatus selectively adjusts a penetration level with respect to the light source. The glare preventing apparatus determines whether to adjust the penetration level based on a property of the light source. For example, the glare preventing apparatus maintains the penetration level with respect to a point on the transparent display that corresponds to a light source identified as having a penetration permission property. Conversely, the glare preventing apparatus reduces the penetration level with respect to a point on the transparent display that corresponds to a light source identified as having a penetration restriction property. Thus, the glare preventing apparatus provides driving safety while alleviating or reducing a visual fatigue of the user, without blocking essential traffic information that needs to be provided to the user.

In operation 232, the glare preventing apparatus reflects the adjusted penetration level in the transparent display. The glare preventing apparatus reduces the penetration level of the target region, and protects the eyes of the user from the glare. The glare preventing apparatus changes the penetration level of the target region on the transparent display with respect to headlights of an oncoming vehicle on an opposite lane such that an opaque shape corresponding to the headlights appears.

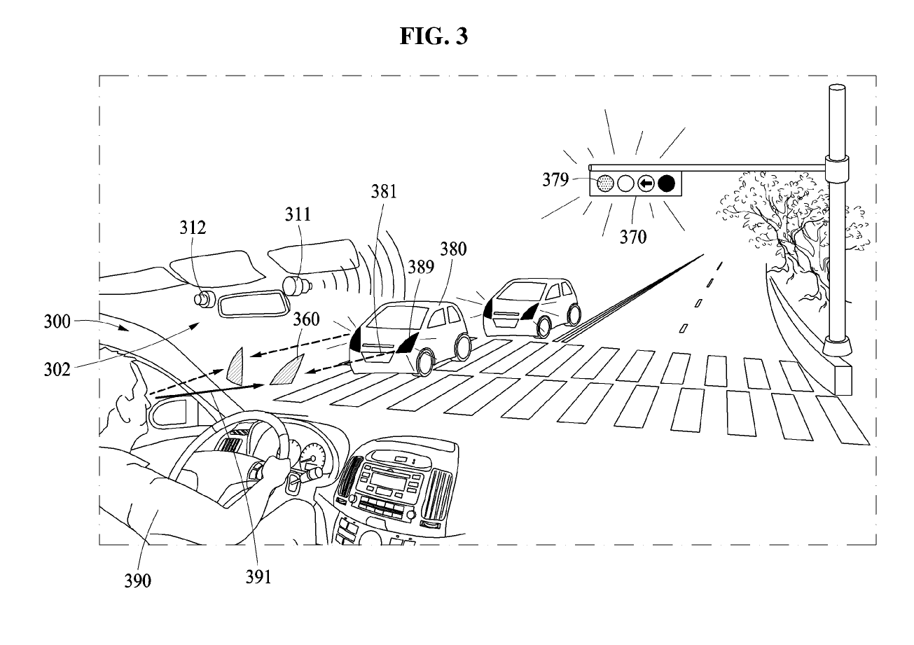

FIG. 3 illustrates an example of a glare preventing apparatus provided in a vehicle 300, according to an embodiment.

Referring to FIG. 3, the glare preventing apparatus detects a glare event that occurs behind a transparent display 302 through a luminance sensor 311. As described above, the glare preventing apparatus determines a target region 360 corresponding to the glare event on the transparent display 302.

For example, a windshield of the vehicle 300 is implemented as the transparent display 302. In FIG. 3, the luminance sensor 311 and a gaze tracker 312 are attached to a rear-view mirror as examples of sensors. However, sensors are not limited to these examples, and the positions and configuration of the sensors may vary according to design objectives.

For example, a gaze 391 of a user 390 in the vehicle is directed to a front side of the vehicle, behind the windshield 302 of the vehicle 300. If another object 380, for example, another vehicle, is approaching from the front side of the vehicle 300, light 381 radiated from a light source 389 of the other vehicle 380, for example, headlights of the other vehicle 380, passes through the windshield 302 and reaches eyes of the user 390. To prevent the light 381, which has a luminance exceeding a threshold luminance, from reaching the eyes of the user 390, the glare preventing apparatus determines the target region 360, which includes a point at which the light 381 radiated from the light source 389 of the object 380 intersects the gaze 391 of the user 390, and reduces a penetration level of the target region 360, thereby preventing glare. The glare preventing apparatus calculates a linear path from the light source 389 to the eyes of the user 390, and determines a point at which the linear path intersects the windshield 302 to be a glare point.

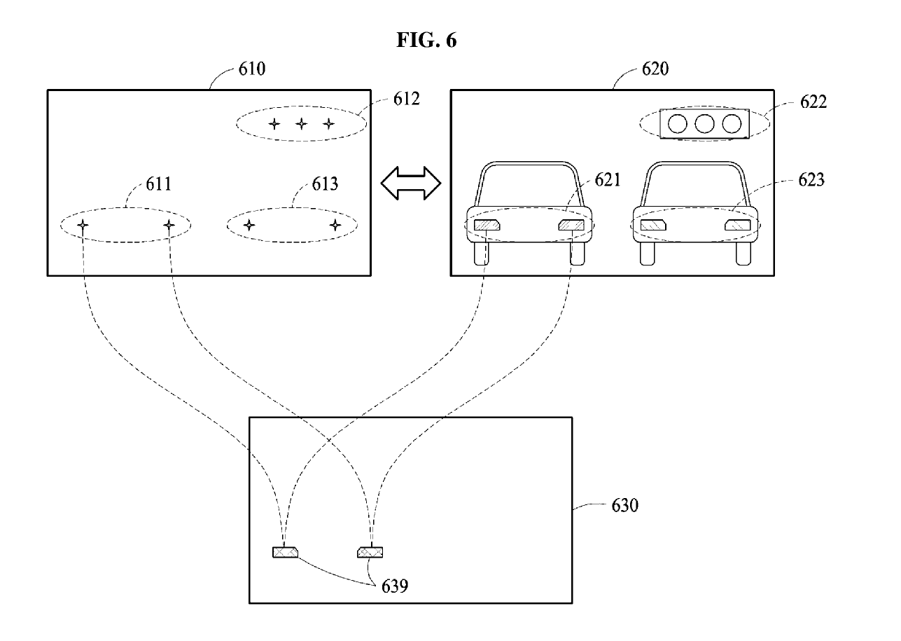

Further, for example, the glare preventing apparatus identifies a property of a light source 379, and determines whether to permit penetration of light radiated from the light source 379 based on the property of the light source 379. For example, the light source 379 is a light source of a traffic light object 370. The glare preventing apparatus maintains a penetration level with respect to light radiated from the light source 379. Thus, the glare preventing apparatus selectively blocks glare caused by another vehicle ahead, without unnecessarily blocking visual information to be provided to a driver of a vehicle. An example of identifying a property of a light source will be described with reference to FIG. 6.

With respect to a strong-intensity light source existing outside of the vehicle 300, the glare preventing apparatus makes a portion of the windshield 302 corresponding to the light source, for example, headlights and taillights, opaque, rather than making the entire windshield 302 darkened, thereby preventing instant blindness caused by glare while allowing the driver to recognize a shape of an object around the light source. Thus, the glare preventing apparatus guarantees the driver safer driving. Furthermore, the glare preventing apparatus provides image recognition with a higher accuracy in autonomous driving and enhances safety of autonomous driving.

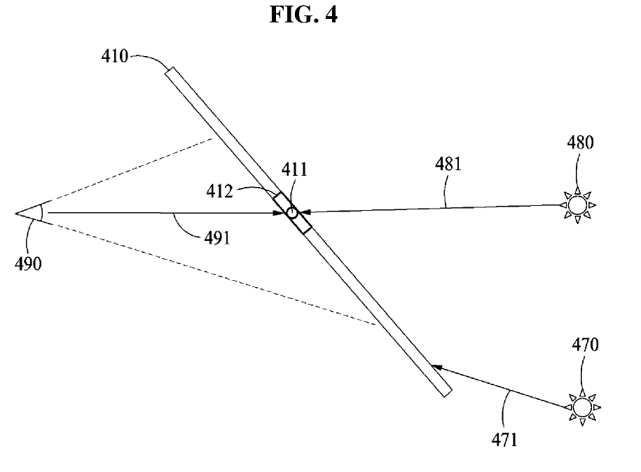

FIG. 4 illustrates an example of a target region 412 determined by a glare preventing apparatus with respect to a transparent display 410, according to an embodiment.

Referring to FIG. 4, the glare preventing apparatus tracks a gaze 491 of a user. The glare preventing apparatus determines a region including a point 411 at which light 481 radiated from a light source 480 toward the transparent display 410 intersects the gaze 491 on the transparent display 410 to be a target region 412. For example, the glare preventing apparatus determines a size and a shape of the target region 412 based on: a distance from one of the glare preventing apparatus, the transparent display 410, and a vehicle to the light source 480; a luminance of the light source 480 obtained through a luminance sensor; and an ambient luminance.

In a case in which light 471 radiated from a light source 470 does not intersect the gaze 491, a glare event corresponding to the light 471 does not influence eyes 490 of the user. The glare preventing apparatus maintains a penetration level of the transparent display 410 with respect to the glare event corresponding to the light 471, without changing the penetration level. Further, the light 471 radiated from the light source 470 is outside of a visible range covered by the eyes 490 of the user. Thus, the glare preventing apparatus excludes the glare event corresponding to the light 471.

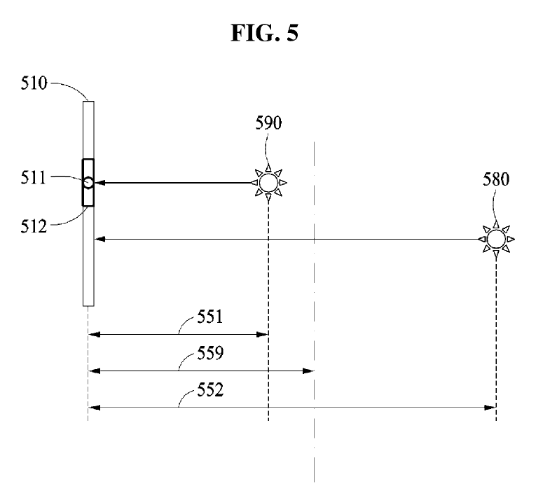

FIG. 5 illustrates an example of determining a penetration level based on a distance by a glare preventing apparatus, according to an embodiment.

Referring to FIG. 5, a glare preventing apparatus adjusts a penetration level of a target region 512 corresponding to a light source 580, 590 in response to a distance 551, 552 between the light source 580, 590 and the glare preventing apparatus including the transparent display 510 being less than a threshold distance 559. The threshold distance 559 is a distance which is a criterion for changing a penetration level, and may vary according to design objectives. The target region 512 is determined based on a point 511 at which light radiated from a light source intersects a gaze of a user.

The glare preventing apparatus enables a driver identification of a distant object by not changing a penetration level with respect to the light source 580 at a distance greater than or equal to the threshold distance 559. Further, the glare preventing apparatus changes a penetration level with respect to the light source 590 at a distance less than the threshold distance 559.

The glare preventing apparatus determines the penetration level based on: a distance from one of the glare preventing apparatus, the transparent display, and a vehicle to the light source; a luminance of the light source obtained through a luminance sensor; and an ambient luminance. For example, the glare preventing apparatus calculates a difference between a luminance of a light source corresponding to a glare event and an ambient luminance of the light source, and determines the penetration level based on the difference. As the difference between the luminance of the light source and the ambient luminance increases, the amount of decrease of the penetration level increases. Conversely, as the difference between the luminance of the light source and the ambient luminance decreases, the amount of decrease of the penetration level decreases.

FIG. 6 illustrates an example of determining a penetration level based on a property of a light source by a glare preventing apparatus, according to an embodiment.

A glare preventing apparatus determines light source information of a light source. For example, the glare preventing apparatus identifies shapes of an object and a light source present ahead of a vehicle through an image sensor, and determines a property of the light source based on the shapes of the object and the light source. The glare preventing apparatus identifies shapes of a traffic light object and taillights of the vehicle based on an image, and determines the property of the light source based on the identified shapes. The glare preventing apparatus determines whether to adjust a penetration level of a region corresponding to the shape of the light source based on the light source information. Further, the glare preventing apparatus determines whether to adjust a penetration level of a target region corresponding to the shape of the light source based on the property of the light source.

In response to the property of the light source corresponding to a penetration permission property, the glare preventing apparatus excludes a change of the penetration level of the region corresponding to the shape of the light source. In FIG. 6, the glare preventing apparatus determines a property of a light source of the traffic light object and a property of a light source of taillights of a vehicle to be penetration permission properties.

In response to the property of the light source corresponding to a penetration restriction property, the glare preventing apparatus changes the penetration level of the region corresponding to the shape of the light source. For example, in response to the property of the light source corresponding to the penetration restriction property, the glare preventing apparatus reduces the penetration level of the region corresponding to the shape of the light source to a restricted level. In FIG. 6, the glare preventing apparatus determines a property of a light source of headlights of a vehicle to be a penetration restriction property. The restricted level is a penetration rate at which glare with respect to eyes of the user is determined to be prevented, and may change according to design.

As shown in FIG. 6, the glare preventing apparatus generates a luminance map 610 by monitoring a luminance with respect to a front side of a transparent display. The glare preventing apparatus generates an ambient space map 620 with respect to the front side of the transparent display. The glare preventing apparatus maps the luminance map 610 and the ambient space map 620.

In response to a glare point 611, 612, 613 having a luminance exceeding a threshold luminance being detected from the luminance map 610, the glare preventing apparatus determines a light source region 621, 622, 623 corresponding to the glare point 611, 612, 613 in the ambient space map 620. The glare preventing apparatus determines a target region 639 of the transparent display based on the light source region 621, 622, 623.

Still referring to FIG. 6, the glare preventing apparatus detects the glare points 611, 612, and 613 from the luminance map 610. As described above, the glare preventing apparatus restricts changes of penetration levels with respect to the glare points 612 and 613 corresponding to light sources having the penetration permission properties.

The glare preventing apparatus identifies the glare point 611 corresponding to the light source having the penetration restriction property from the luminance map 610, and determines the region 621 corresponding to the glare point 611 based on the ambient space map 620. For example, the glare preventing apparatus extracts the region 621 corresponding to the light source having the penetration restriction property by analyzing the ambient space map 620. The glare preventing apparatus determines target regions 639 on a transparent display 630, and reduces penetration levels of the target regions 639.

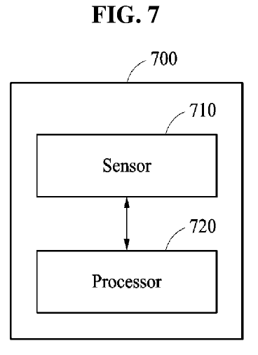

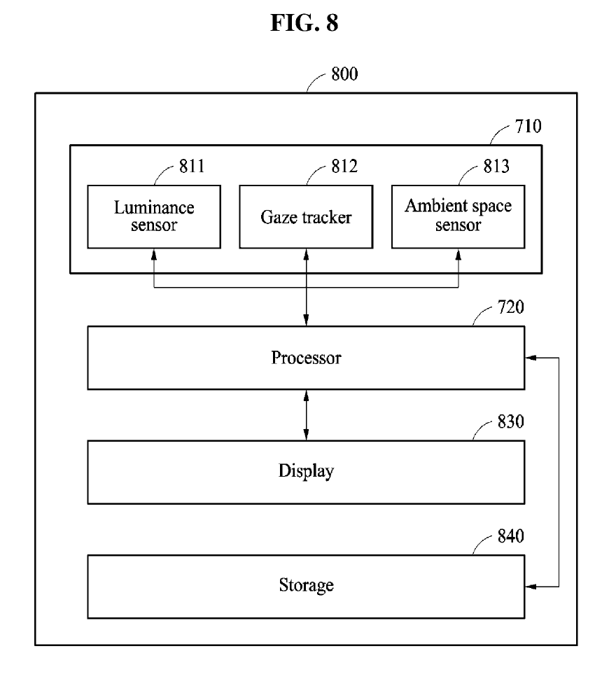

FIGS. 7 and 8 are block diagrams illustrating examples of glare preventing apparatuses 700 and 800, according to an embodiment.

Referring to FIG. 7, the glare preventing apparatus 700 includes a sensor 710 and a processor 720.

The sensor 710 detects a glare event with respect to a transparent display.

The processor 720 identifies a light source corresponding to the glare event, and adjusts a penetration level of a target region corresponding to a shape of the light source in the transparent display.

The processor 720 determines light source information of the light source, and determines whether to adjust a penetration level of a region corresponding to the shape of the light source based on the light source information. In response to a property of the light source corresponding to a penetration permission property, the processor 720 excludes a change of the penetration level of the region corresponding to the shape of the light source. In response to the property of the light source corresponding to a penetration restriction property, the processor 720 changes the penetration level of the region corresponding to the shape of the light source. In response to the property of the light source corresponding to the penetration restriction property, the processor 720 reduces the penetration level of the region corresponding to the shape of the light source to a restricted level.

However, the apparatus 700 is not limited to the example discussed above. Referring to FIG. 8, a glare preventing apparatus 800 further includes a display 830 and a storage 840.

The display 830 is, for example, a transparent display viewed by a user. The transparent display 830 controls a penetration level of one or more regions thereof. In a case in which the display 830 includes a plurality of layers, the display 830 controls a penetration level of at least one of the layers. For example, the transparent display 830 is a windshield of a vehicle. The transparent display 830 adjusts the penetration level of at least one region, for example, a target region, based on a voltage applied by the processor 720. Further, the display 830 includes a head-up display (HUD).

The storage 840 stores program instructions to operate the processor 720. Further, the storage 840 stores a luminance map, an ambient space map, and a 3D geometric model with respect to various light sources.

The sensor 710 includes a luminance sensor 811, a gaze tracker 812, and an ambient space sensor 813.

The luminance sensor 811 monitors a luminance with respect to a front side of the transparent display 830. Further, the luminance sensor 811 generates a luminance map by monitoring the luminance with respect to the front side of the transparent display 830.

The gaze tracker 812 tracks a gaze of the user.

The ambient space sensor 813 generates an ambient space map indicating distances from the glare preventing apparatus 800 to objects positioned in front of the transparent display 830. The ambient space sensor 813 generates the ambient space map with respect to the front side of the transparent display 830. For example, the ambient space sensor 813 includes any one of a LiDAR sensor, a radio detection and ranging (RADAR) sensor, and a stereo camera.

The sensor 710, the processor 720, the luminance sensor 811, the gaze tracker 812, the ambient space sensor 813, the display 830, and the storage 840 in FIGS. 7 and 8 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1, 2, 5 and 6 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method to prevent glare, the method comprising:
detecting a glare with respect to a transparent display;
identifying a light source corresponding to the glare; and
setting a penetration level of a target region corresponding to a shape of the light source in the transparent display.

2. The method of claim 1, wherein
the identifying of the light source comprises determining light source information of the light source, and
the setting of the penetration level of the target region comprises determining whether to adjust the penetration level of the target region based on the light source information.

3. The method of claim 1, wherein the setting of the penetration level of the target region comprises excluding a change of the penetration level of the target region, in response to a property of the light source corresponding to a penetration permission property.

4. The method of claim 1, wherein the setting of the penetration level of the target region comprises changing the penetration level of the target region, in response to a property of the light source corresponding to a penetration restriction property.

5. The method of claim 1, wherein the setting of the penetration level of the target region comprises reducing the penetration level of the target region to a restricted level, in response to a property of the light source corresponding to a penetration restriction property.

6. The method of claim 1, further comprising:
tracking a gaze of a user,
wherein the identifying of the light source comprises determining a region including a point at which light projected from the light source toward the transparent display intersects the gaze on the transparent display to be the target region.

7. The method of claim 1, wherein the detecting of the glare comprises
monitoring a luminance with respect to a front side of the transparent display; and
detecting an occurrence of the glare in response to the monitored luminance exceeding a threshold luminance.

8. The method of claim 1, further comprising:
generating an ambient space map indicating distances from an apparatus comprising the transparent display to objects positioned in front of the transparent display.

9. The method of claim 1, wherein the setting of the penetration level of the target region comprises adjusting the penetration level of the target region, in response to a distance between the light source and an apparatus comprising the transparent display being less than a threshold distance.

10. The method of claim 1, further comprising:
generating a luminance map by monitoring a luminance with respect to a front side of the transparent display;
generating an ambient space map with respect to the front side of the transparent display; and
mapping the luminance map and the ambient space map,
wherein the identifying of the light source comprises
determining a light source region corresponding to a glare point in the ambient space map in response to the glare point being detected from the luminance map, the glare point having a luminance exceeding a threshold luminance, and
determining the target region based on the light source region.

11. A non-transitory computer-readable medium storing instructions that, when executed by a processor, cause the processor to perform the method of claim 1.

12. An apparatus to prevent glare, the apparatus comprising:
a sensor configured to detect a glare with respect to a transparent display; and
a processor configured to identify a light source corresponding to the glare, and to set a penetration level of a target region corresponding to a shape of the light source in the transparent display.

13. The apparatus of claim 12, wherein the processor is configured to determine light source information of the light source, and to determine whether to adjust the penetration level of the target region based on the light source information.

14. The apparatus of claim 12, wherein the processor is further configured to exclude a change of the penetration level of the target region, in response to a property of the light source corresponding to a penetration permission property.

15. The apparatus of claim 12, wherein the processor is further configured to change the penetration level of the target region, in response to a property of the light source corresponding to a penetration restriction property.

16. The apparatus of claim 12, wherein the processor is further configured to reduce a penetration level of the target region, in response to a property of the light source corresponding to a penetration restriction property.

17. The apparatus of claim 12, wherein
the sensor comprises a gaze tracker configured to track a gaze of a user, and
the processor is further configured to determine a region comprising a point at which light projected from the light source toward the transparent display intersects the gaze on the transparent display to be the target region.

18. The apparatus of claim 12, wherein
the sensor comprises a luminance sensor configured to monitor a luminance with respect to a front side of the transparent display, and
the processor is further configured to detect an occurrence of the glare in response to the monitored luminance exceeding a threshold luminance.

19. The apparatus of claim 12, wherein
the sensor comprises an ambient space sensor configured to generate an ambient space map indicating distances from the apparatus to objects positioned in front of the transparent display, and
the processor is further configured to adjust the penetration level of the target region, in response to a distance between the light source and the apparatus being less than a threshold distance.

20. The apparatus of claim 12, wherein
the sensor comprises a luminance sensor configured to generate a luminance map by monitoring a luminance with respect to a front side of the transparent display, and an ambient space sensor configured to generate an ambient space map with respect to the front side of the transparent display, and
the processor is further configured to determine a light source region corresponding to a glare point in the ambient space map, in response to the glare point being detected from the luminance map, the glare point having a luminance exceeding a threshold luminance, and to determine a target region of the transparent display based on the light source region.
